(19) United States
(12) Patent Application Publication
(10) Pub. No.: US 2006/0074710 A1
(43) Pub. Date: Apr. 6, 2006

(54) Healthcare revenue cycle management system

(76) Inventors: Michael K. Funk, Powder Springs, GA (US); Randall C. Clark, Tarzana, CA (US)

Correspondence Address: Scot A. Reader, Esq., Suite 228, 1320 Pearl Street, Boulder, CO, 80302, US

(21) Appl. No.: 10/954,393

(22) Filed: Sep. 30, 2004

(51) Int. Cl. G06Q 10/00; G06Q 50/00

(52) U.S. Cl. 705/2

(57) ABSTRACT

A healthcare revenue cycle management analytics system enables healthcare business professionals to perform multidimensional data analysis without the assistance of IT or analyst intermediaries. The system provides a user interface which presents views selectable by a user from a plurality of built-in views relevant to healthcare revenue cycle management. The system further provides a user interface having a tree-like filter made up of numerous relevant dimensions and members of target data sources for highly granular control over the data populating the built-in revenue cycle visualizations. The system further allows healthcare business professionals to access healthcare revenue cycle management data over the Internet, via a web services approach.

### BACKGROUND OF THE INVENTION

The present invention relates to business intelligence systems, and more particularly to the healthcare revenue cycle management domain. Business intelligence systems are software-based systems that enable multidimensional, analytically-based user access to datasets. Prior to the birth of the term “business intelligence”, the information technology (IT) industry commonly referred to such systems as on-line analytical processing (OLAP) systems. Healthcare revenue cycle management is the business function whereby clinical healthcare services are captured, coded, billed and converted to cash; central to this process is the function of accounts receivable (AR) management.

A conventional approach taken by healthcare business professionals to meet their analytical needs has relied on transaction-based systems and “canned” reports generated from such systems. Transaction-based systems, which enable healthcare transactions to be added, edited or deleted, are sometimes referred to in the IT industry as on-line transaction processing (OLTP) systems. “Canned” reports generated by these systems have provided useful information regarding the transactions entered, but have fallen short in supporting more sophisticated analytical efforts.

In addition to “scanned” reports, ad-hoc queries have been used to extract more detailed information from OLTP systems for analytical purposes. Reliance on ad-hoc queries to retrieve more complex data from OLTP systems has had several shortcomings, however. First, since this approach has typically involved executing structured query language (SQL)-oriented statements it has required technical capabilities that most healthcare business professionals do not possess. Second, computer processing of ad-hoc queries is often slow, taking minutes, hours or even days to complete. As a result of these constraints, healthcare business professionals have typically relied on IT personnel to execute ad-hoc queries on their behalf. The need for IT intermediaries has slowed the overall analytical cycle considerably. Furthermore, the lack of appropriate formatting of the output data has often necessitated additional post-processing efforts on the part of the healthcare business professional to place the data into a usable form. These efforts have frequently involved importing this data into spreadsheet software and “massaging” and manipulating the data until the desired formatting has been achieved, and have consumed valuable human capital.

More recently, business intelligence systems have been introduced to the healthcare market, but with minimal success. Building on available OLAP software, systems have been developed that have taken healthcare revenue cycle management data analysis outside of the OLTP system realm. To the extent that healthcare provider organizations now have an option outside of “canned” reporting and ad-hoc SQL queries, these solutions have represented a positive step.

However, there are key deficiencies with known business intelligence systems for the healthcare revenue cycle management domain. First, by relying on industry standard OLAP client software, these products still require too much technical expertise on the part of the user; simply put, they are not user-friendly enough for the typical healthcare business professional. As a result of this deficiency, the mainline healthcare business professional is unable and/or unwilling to use these products to support their analytical needs. Like the conventional approaches discussed above (e.g. ad-hoc SQL queries), many professionals have been forced to route analytical requests to either IT intermediaries, or an even more specialized category of expert user referred to as an analyst. Representing only a small fraction of all healthcare business professionals, IT personnel and/or analysts are generally the only users of these types of products. Thus, although in some respects better than the conventional approach, the resulting analytical capabilities under these technically difficult solutions have been both inefficient (still requiring an intermediary) and ineffective, and the ultimate objective of “self-service” analysis by most healthcare business professionals has remained elusive.

Another deficiency of known business intelligence systems for revenue cycle management is that they have failed to sufficiently support the comprehensive demands of this domain. With myriad subject matter areas making up healthcare revenue cycle management (i.e. service productivity, collection performance, reimbursement analysis, accounts receivable management, charge lag analysis, credit balance analysis, cash flow trending, etc.), providing specific visualizations relating to these disparate areas has proven a critical requirement to make a platform useful across the multitude of healthcare business professionals within large organizations.

A third shortcoming of known business intelligence systems for revenue cycle management is the data access methodology, both in terms of limits on flexibility of usage and unnecessary maintenance expense. Known systems have typically required hosting of a “data cube,” e.g. a large store of pre-compiled data, on the healthcare organization's premises. IT resources have been required to maintain and support these large data structures and user connectivity thereto. Additionally, access to these data warehouses has typically been unavailable to employees when not present on the organization's premises.

### SUMMARY OF THE INVENTION

The present invention addresses the above deficiencies and transforms the nature in which healthcare business professionals carry out analytical efforts. The present invention allows healthcare business professionals to execute “self-service” multidimensional data analysis, rather than relying on IT or analyst intermediaries. By circumventing technical intermediaries, the present invention creates more efficient and effective analysis of the healthcare revenue cycle. The present invention further enables healthcare business professionals to access healthcare revenue cycle management data over the Internet, via a web services approach and effectively creates a new, outsourcing market for hosted analytics solutions within this domain. By outsourcing technical support, functional support and maintenance for the decision-support function within healthcare revenue cycle management to an application service provider (ASP), the burden on healthcare organizations' IT budgets, collectively, can be significantly reduced.

In one aspect, the present invention provides a user interface for a healthcare revenue cycle data analysis system which presents visualizations, or views, selectable by a user from a plurality of built-in views widely used in the healthcare revenue cycle management domain. These built-in views afford the user interactive access to healthcare revenue cycle performance metrics across an array of subject areas that comprise this complex function. In essence, the system integrates the views that most healthcare business professionals care about so that they don't have to create them from scratch or triage to IT/analyst intermediaries.

In another aspect, the present invention provides a user interface for a healthcare revenue cycle data analysis system with highly granular filtering capabilities, including a tree-like filter made up of numerous relevant dimensions and members of target data sources. The tree-like filter allows users, through point-and-click selection and de-selection, to precisely control the data that populates views, and without need for technical intermediaries. Furthermore, the user interface gives users command over additional controls such as metric combo boxes (drop down controls where the users can choose the metric that they want to see visualized) and yes/no check boxes to include/exclude different types of data records.

In another aspect, the present invention provides a healthcare revenue cycle data analysis system that enables healthcare business professionals to access revenue cycle data over the Internet via a web services approach. This web services approach creates greater flexibility and markedly reduced maintenance and support costs relative to known systems. First, it enables authorized healthcare business professionals to access their revenue cycle data from any end system having appropriate software and Internet connectivity, regardless of physical location. Second, it allows healthcare organizations to make use of pooled data storage facilities and IT experts, for example, at a health care revenue cycle management decision-support ASP. Third, unlike traditional browser-based approaches that leverage the Internet, the web service method of the present invention has significantly better query response times. With browser-based approaches, the entire view, along with the requested data, is pulled from the Internet each time a query is executed, typically via HyperText Markup Language (HTML). The web services methods of the present invention, through the expedient of a user interface application on the end system and a web services application coupled between the end system and the data source, require that only the requested data, and not the entire view, be pulled from the Internet. This distinction is profound as it has enabled the present invention to have much “snappier” refreshes than browser-based systems.

In yet another aspect, the present invention provides a healthcare revenue cycle data analysis system that enables healthcare business professionals to extract and export into a standard spreadsheet application detailed data records associated with any visualization. Within any view, or after any filter has been applied and aggregated data has been pulled over the Internet, the user can activate a simple control enabling the user to select for export elements of data records that underlie the visualization being presented to them at the time. When the data export request is initiated by the user, the web services methods of the present invention generate and present the selected elements to the user within a standard spreadsheet application, professionally formatted.

These and other aspects of the invention will be better understood by reference to the detailed description of the preferred embodiment taken in conjunction with the drawings briefly described below. Of course, the invention is defined by the appended claims.

### BRIEF DESCRIPTION OF THE DRAWINGS

FIG. 1 is a block diagram illustrating a healthcare revenue cycle data analysis system in accordance with a preferred embodiment of the invention.

FIG. 2 is a flow diagram illustrating a user connection process in accordance with a preferred embodiment.

FIG. 3 is a flow diagram illustrating a process for obtaining source database settings in accordance with a preferred embodiment.

FIG. 4 is a flow diagram illustrating a process for obtaining filter list data in accordance with a preferred embodiment.

FIG. 5 is a flow diagram illustrating a process for obtaining a visualization update in accordance with a preferred embodiment.

FIG. 6 is an exemplary user screen illustrating a startup form presented to a user upon executing a user interface application (UIA).

FIG. 7 is an exemplary user screen illustrating a login form presented to a user.

FIG. 8 is an exemplary user screen illustrating an updated login form presented to a user.

FIG. 9 is an exemplary user screen illustrating a production trending analysis presented to a user.

FIG. 10 is a modified version of the user screen of FIG. 9 illustrating controls available to the user for manipulating views in a preferred embodiment.

FIG. 11 is an exemplary user screen illustrating a production top “X” analysis presented to a user.

FIG. 12 is an exemplary user screen illustrating a production payor mix analysis presented to a user.

FIG. 13 is an exemplary user screen illustrating a collection performance analysis presented to a user.

FIG. 14 is an exemplary user screen illustrating a reimbursement trending analysis presented to a user.

FIG. 15 is an exemplary user screen illustrating a CPT (current procedural terminology) code reimbursement comparison presented to a user.

FIG. 16 is an exemplary user screen illustrating a reimbursement lost charge analysis presented to a user.

FIG. 17 is an exemplary user screen illustrating an accounts receivable distribution analysis presented to a user.

FIG. 18 is an exemplary user screen illustrating accounts receivable performance metrics presented to a user.

FIG. 19 is an exemplary user screen illustrating an accounts receivable over/under analysis presented to a user.

FIG. 20 is an exemplary user screen illustrating a charge lag trending analysis presented to a user.

FIG. 21 is a flow diagram illustrating a process for extracting and exporting detail data records in accordance with a preferred embodiment.

FIG. 22 is an exemplary user screen illustrating a field selection form presented to a user for detail data record extraction and export.

FIG. 23 is an exemplary user screen illustrating a modified version of a field selection form presented to a user for detail data record extraction and export.

### DETAILED DESCRIPTION OF THE PREFERRED EMBODIMENT

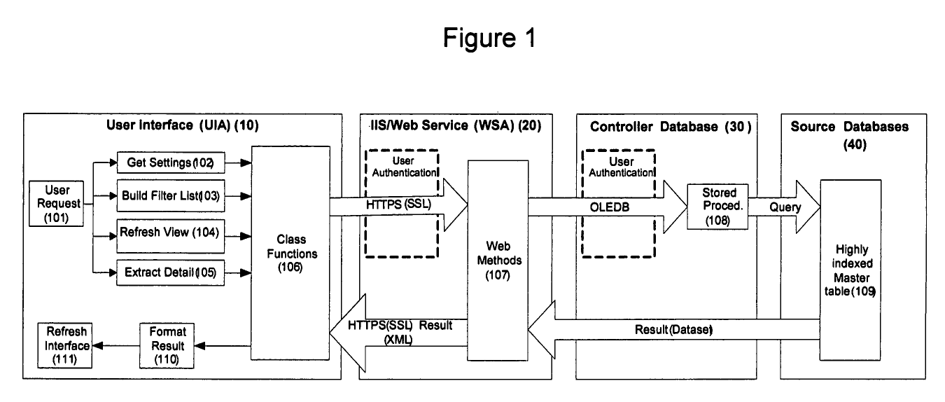

In FIG. 1, a healthcare revenue cycle data analysis system in accordance with a preferred embodiment of the invention is shown. The system includes a user interface application (UIA) 10, a Web service application (WSA) 20, a controller database 30 and source databases 40. UIA 10 is a compiled software application, such as a Microsoft NET application, loadable onto a memory of an Internet-capable client node having a user interface, such as a personal computer (PC) or a workstation, and having instructions executable by a processor on the client node. WSA 20 is a complied software application, such as a Microsoft .NET application, loadable onto a memory of a server node which the client node is connected via the Internet and having instructions executable by a processor on the server node. Controller database 30 is a data storage control facility, such as an SQL server, including a processor and memory having stored therein system level information and procedures used to access data in source databases 40. Source databases 40 include one or more data storage facilities, such as SQL servers, each including a processor and a memory having a master data table with revenue cycle management datasets stored therein. WSA 20, controller database 30 and source databases 40 may reside on one or more network nodes.

UIA 10 is a health care revenue cycle data analysis software application. UIA 10 includes user request function 101; get settings function 102, build filter list function 103, refresh visualization function 104, extract detail function 105, class functions 106, result format function 110 and interface refresh function 111. User request function 101 is a routine that monitors for events from users in the form of, for example, keystrokes or mouse clicks entered on the client node. Get settings, build filter list, refresh visualization and extract detail functions 102, 103, 104, 105 are routines that receive events of their respective types, generate user requests and transmit the user requests to class functions 106. Class functions 106 are routines that accept user requests, translate user requests into parameters for a specified web method supported by WSA 20 and transmit the parameters to WSA 20 over the Internet using Hypertext Transfer Protocol, Secure (HTTPS). Result format function 110 is a routine that prepares result data returned from WSA 20 for viewing on the user interface of the client node. Result format function 110 includes decrypting eXtensible Markup Language (XML)-encrypted ADO.NET datasets received from WSA 20. Interface refresh 111 is a routine that displays the result data on the user interface of the client node.

WSA 20 is an application that exposes web methods made available for consumption by UIA 10. WSA 20 includes web methods 107 for receiving parameters for a supported web method, translating the parameters into OleDB commands and transmitting the commands to controller database 30 for execution. Web methods 107 also receive query results returned from controller database 30 as ADO.NET datasets, XML-encrypt the results and transmit the results via HTTPS to UIA 10.

Controller database 30 is a data storage control facility that includes SQL code for generating SQL queries. Controller database 30 includes stored procedures for receiving OleDB commands from WSA 20, translating the OleDB commands into SQL queries and submitting the queries to appropriate ones of source databases 40.

Source databases 40 are data storage facilities that process SQL queries and return datasets. Source databases 40 each include a highly indexed master table 109 and support tables (not shown) for storing health care revenue cycle datasets. Revenue cycle datasets for a particular healthcare organization may reside on a single one of source databases 40 or may be distributed across multiple ones of source databases 40. Source databases 40 receive SQL queries and return matching ADO.NET datasets in response to the queries. The matching ADO.NET datasets are transmitted via controller database 30 to WSA 20.

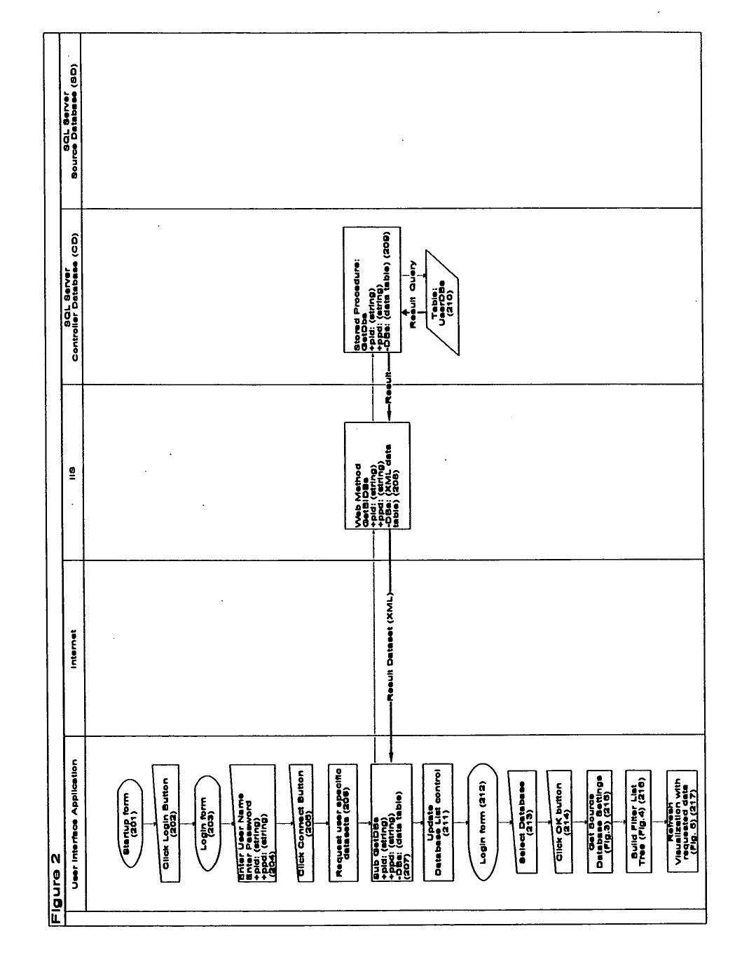

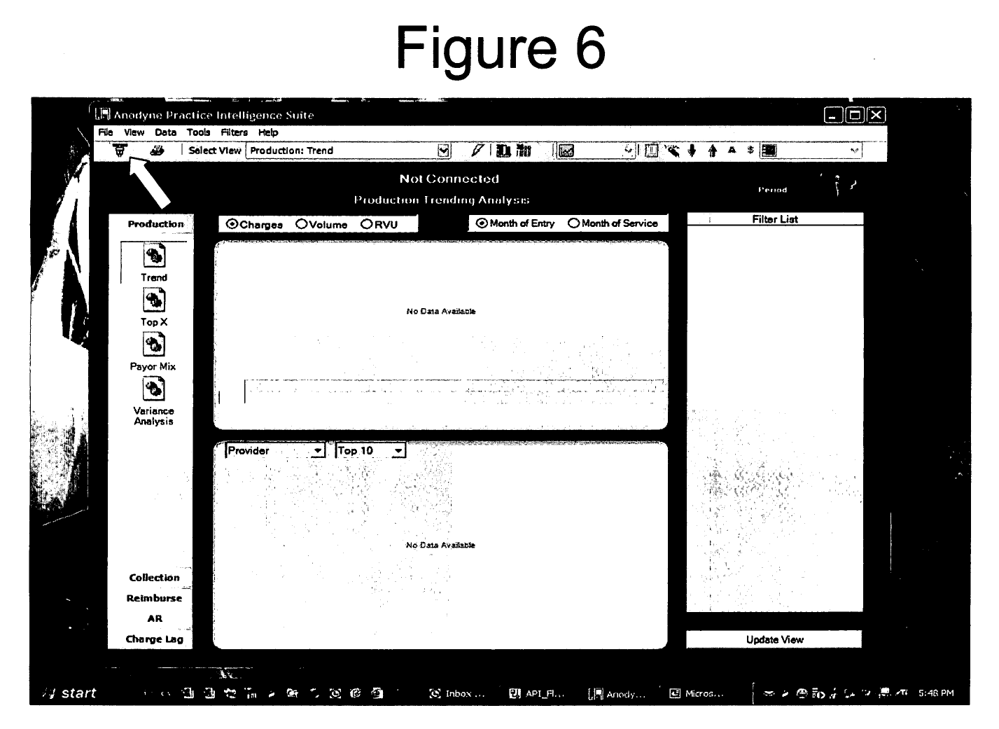

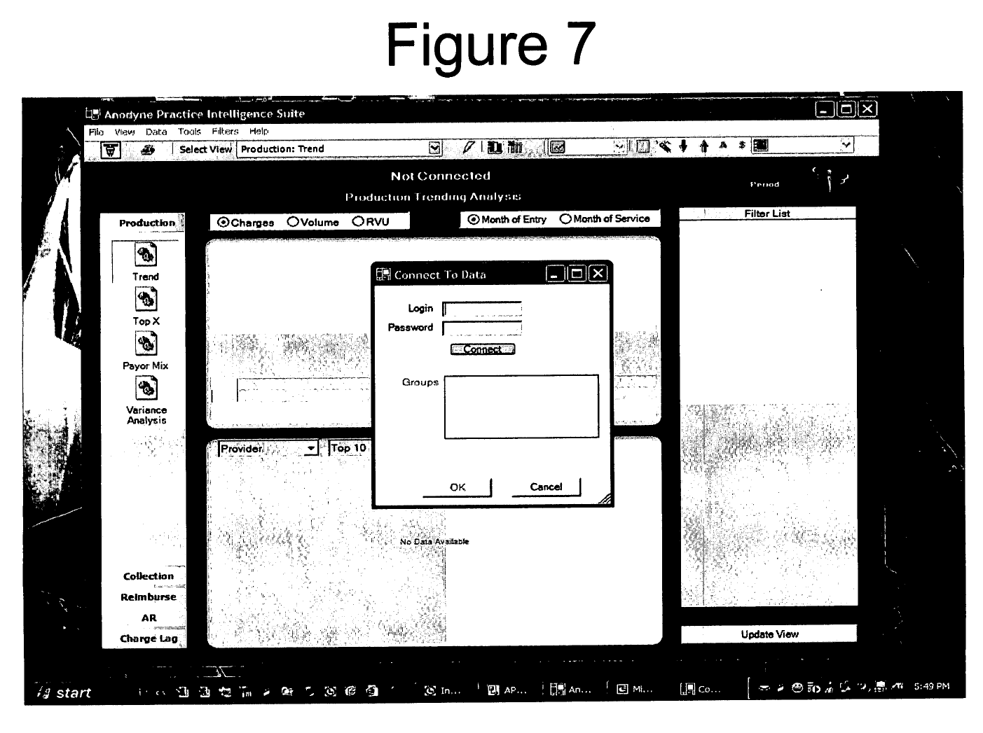

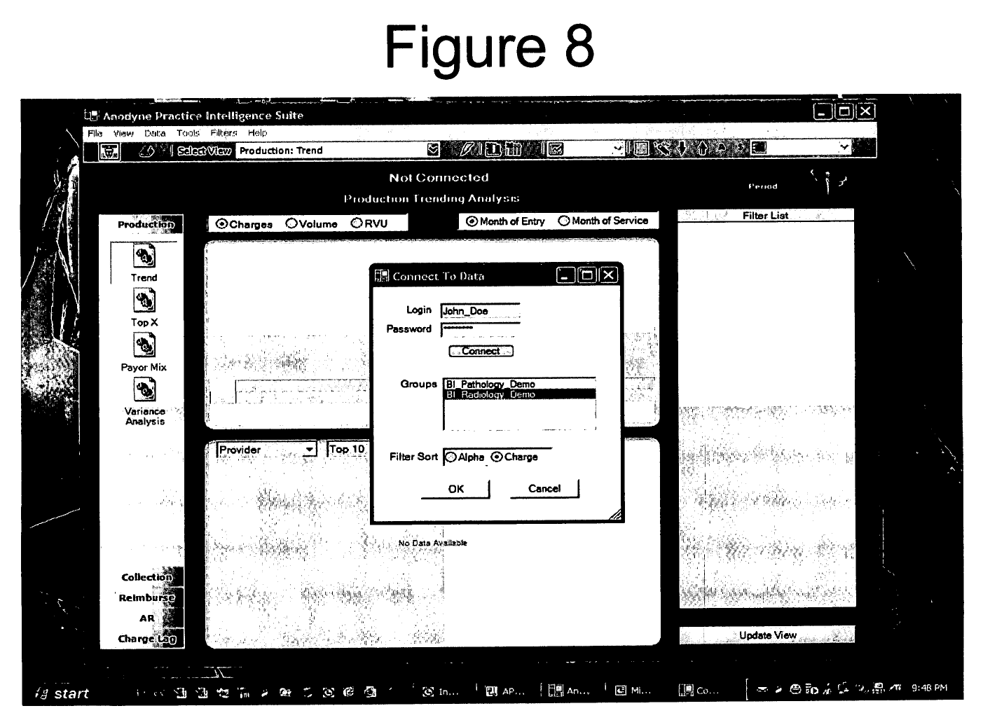

Turning to FIG. 2 in conjunction with FIGS. 6-8, a user connection process in accordance with a preferred embodiment is shown. A user launches UIA 10 on a client node and is presented with a startup form shown in FIG. 6 (201). The user clicks the connect button identified by the arrow on FIG. 6 (202) and is presented with a login form shown in FIG. 7 (203). The user inputs login information, including a user name and password (204) and clicks the connect button (205). The user name and password are transmitted and authenticated on WSA 20 and the GetDBs subroutine on UIA 10 is launched (206). Upon launch, a VB.NET sub-procedure of the GetDBs subroutine calls the GetBIDBs web method on WSA 20 and passes parameters (207). The GetBIDBs web method in turn passes the user name to the GetDBs stored procedure on the controller database 30 (208). The GetDBs stored procedure queries a user database table on controller database 30 (209, 210) and returns a list of the ones of source databases 40 that the user is authorized to access. The result is returned to UIA 10 and a sub-procedure on UIA 10 updates the login form with the list of the authorized ones of source databases 40 as shown in FIG. 8 (211, 212). At that point, the user selects a database from the list of authorized databases (213) and clicks the “OK” button (214). This event prompts get settings function 102, build filter list function 103 and refresh visualization function 104 to initiate respective requests for datasets from the selected one of source databases 40 (215, 216, 217).

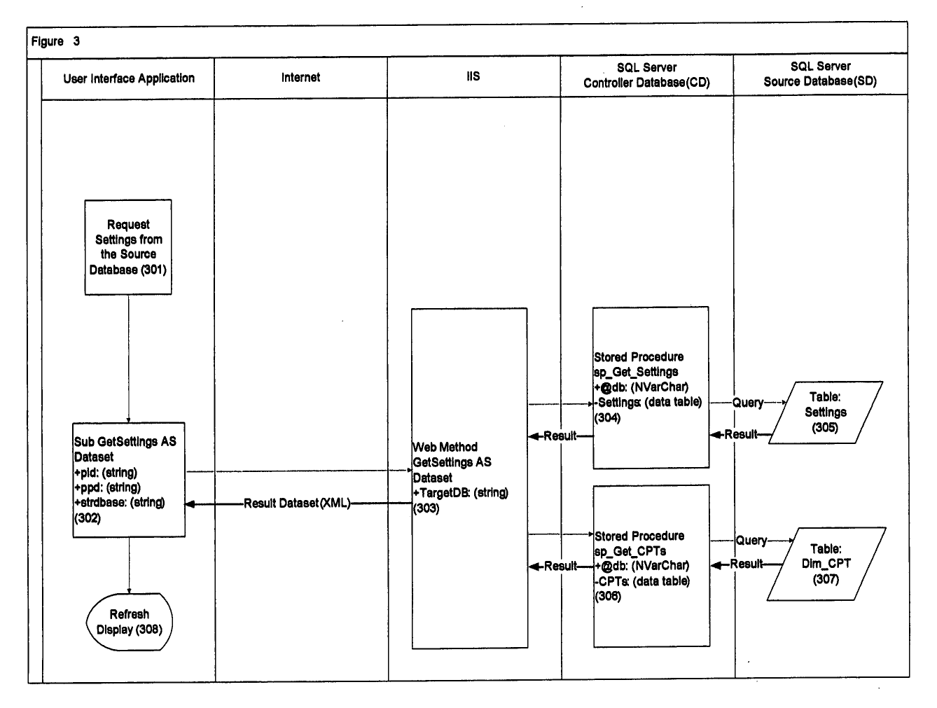

Turning now to FIG. 3, a process for obtaining source database settings in accordance with a preferred embodiment is shown. Upon execution of Step 214, a VB.NET sub-procedure of the GetSettings subroutine on UIA 10 calls the GetBIDBs web method on WSA 20 and passes parameters (301, 302). The GETBIDBs web method in turn issues one or more commands to the Get Settings and Get CPTs stored procedures on controller database 30 (303) which in turn query the settings and DimCPT tables on the selected one of source databases 40 (304, 305, 306, 307). The settings table stores the selected source database's settings and the DimCPT table contains the selected source database's CPT codes. CPT codes are codes that identify the medical procedures performed by healthcare providers. The Get Settings and Get CPTs stored procedures return the settings and CPT codes, respectively, via WSA 20 to UIA 10 at which point result format function 110 integrates the data and prepares it for display on the user interface of the client node (308).

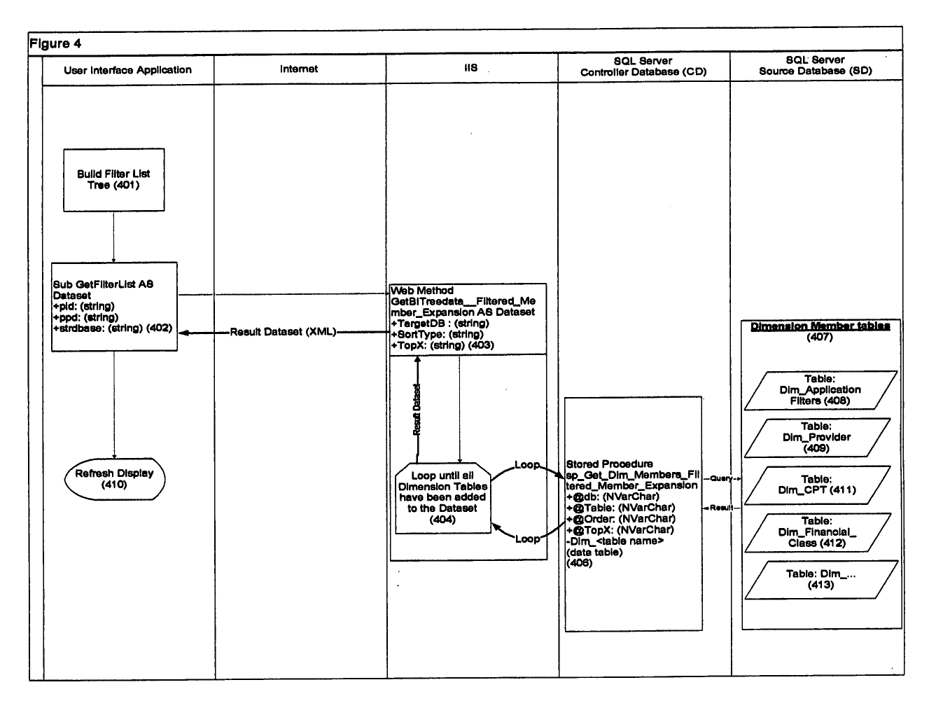

Turning now to FIG. 4, a process for obtaining filter list data in accordance with a preferred embodiment is shown. Upon completion of Step 215, a VB.NET sub-procedure of the GetFilterList subroutine on UIA 10 calls the GetBITreedata Filtered Member Expansion web method on WSA 20 and passes parameters (401, 402). The GetBITreedata Filtered Member Expansion web method in turn issues a series of commands to the GetDimMembers Filtered member Expansion stored procedure on controller database 30 (403, 404) which in turn queries the dimension member tables on the selected one of source databases 40 (406, 407). The dimension member tables store the dimensions and member nodes for the tree-like filter list for display on the user interface. Particularly, the DimApplication Filters table includes top level nodes, or dimension nodes, for the filter list tree. The DimProvider, DimCPT, DimFinanicialClass include sub-nodes, or member nodes, of the dimension nodes of filter list tree. Additional member node tables may be configured if desired. As shown, the GetBITreedata Filtered Member Expansion web method and Get GetDimMembers Filtered member Expansion stored procedure perform in a loop (404); that is, a sequence of commands and queries are submitted to obtain results from respective dimension member tables (403, 406, 408, 409, 411, 412, 413) until the dimensions and members nodes from all tables have been added to the dataset. The Get GetDimMembers Filtered member Expansion stored procedures return the data set via WSA 20 to UIA 10 at which point the result format function 110 integrates the data and prepares it for display on the user interface of the client node (410).

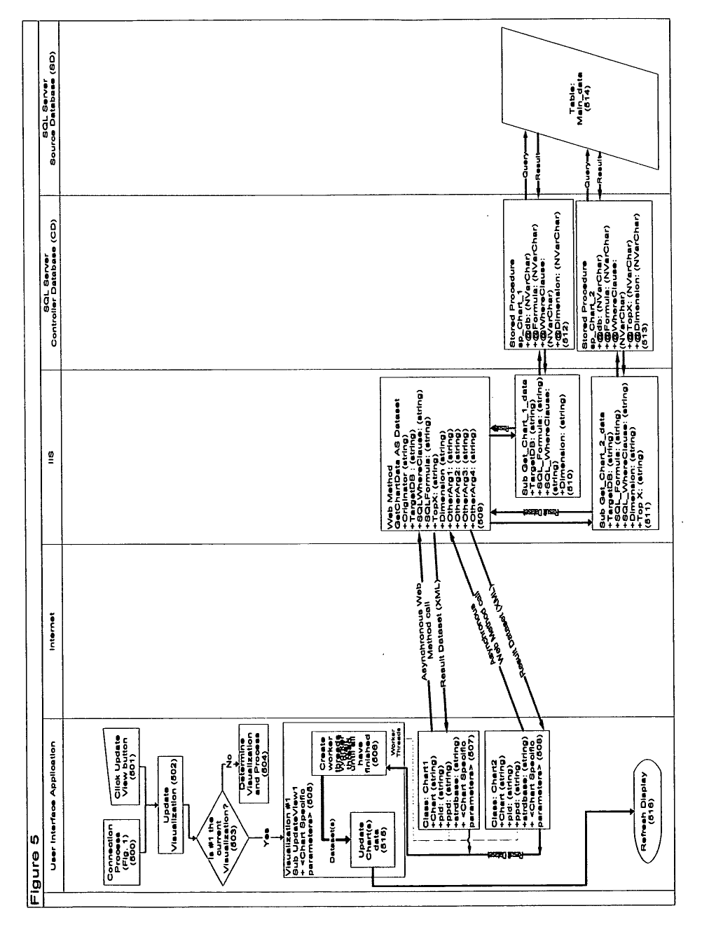

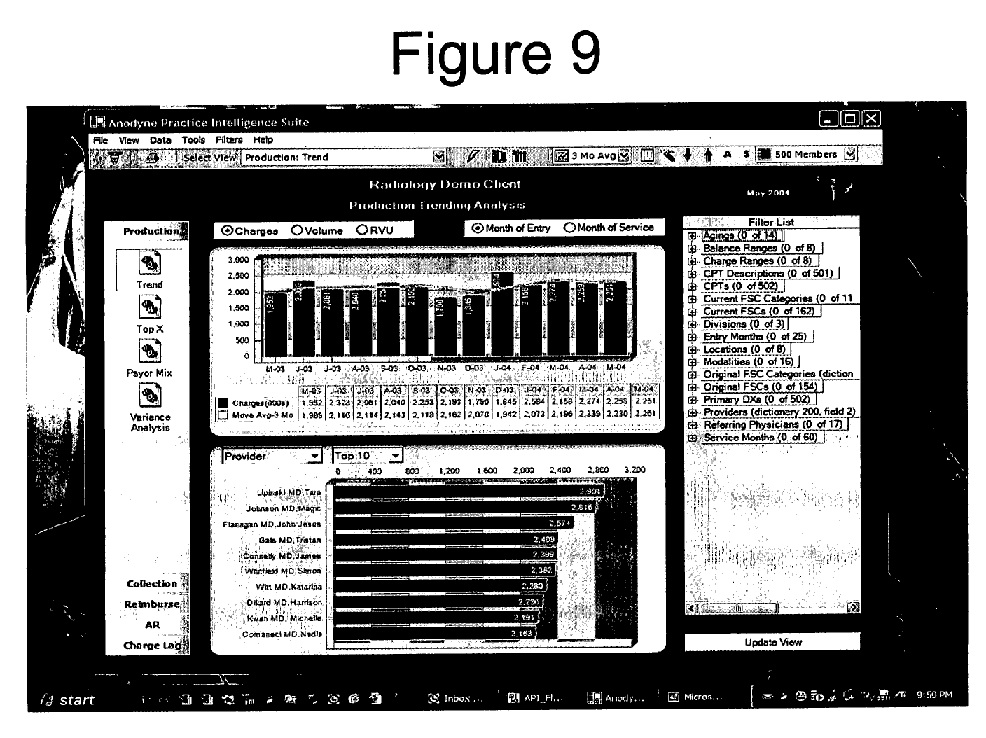

Turning now to FIG. 5, a process for obtaining an updated visualization in accordance with a preferred embodiment is shown. “Visualization” and “view” are used herein synonymously. A visualization refresh may be triggered either by completion of Step 216 (500) or by a user click on the “Update View” button near the bottom right hand corner of the user screen shown, for example, in FIG. 9 (501). Upon completion of Step 216 or upon an “Update View” event, a VB.NET sub-procedure on UIA 10 determines the current visualization number (503, 504). Once the current visualization number is determined, a VB.NET sub-procedure of UIA 10 calls, for each chart in the visualization, the GetChartData web method on WSA 20 and passes chart-specific parameters (507, 508). Calls for different charts are issued asynchronously on different threads. The GetChartData web method in turn issues, for each call, one or more chart-specific commands to a chart-specific stored procedure on controller database 30 (510, 511, 512, 513) which in turn issue respective queries to the main data table on the selected one of source databases 40 (514). The main data table contains all the detail data required to populate the subject charts. The chart-specific stored procedures return the data set via WSA 20 to UIA 10 at which point result format function 110 integrates the data and prepares it for display on the user interface of the client node (410). Once all threads have completed and the data have been integrated, refresh interface function 111 refreshes the display.

Turning now to FIG. 9, an exemplary production trending analysis user screen presented to a user is shown. This view enables the user to visualize a 24-month trend of various production-oriented metrics, such as procedure volumes and relative value units. There is a horizontal scroll bar on the top column chart, as well as the top table, which enables the user access to all of the months within the trend. There is a moving averaging component on the top chart which can be modified by utilizing the combo box in the top right portion of the tool bar. The table in the top chart displays the data associated with the top chart. The bottom bar chart displays the top “X” members of the dimension that has been selected within the combo box of said chart. The top “X” members are selected based on the charge levels (by dollar value) indicated by the filtered data set. The members within this chart are sorted in descending order based on the value of the production and calendaring metrics that has been selected in the top option box (above top chart). The user screen also includes a filter list having dimensions that can be selected or de-selected to modify the data populations included in and excluded from the visualizations based on numerous dimensions commonly used in health care revenue cycle data analysis.

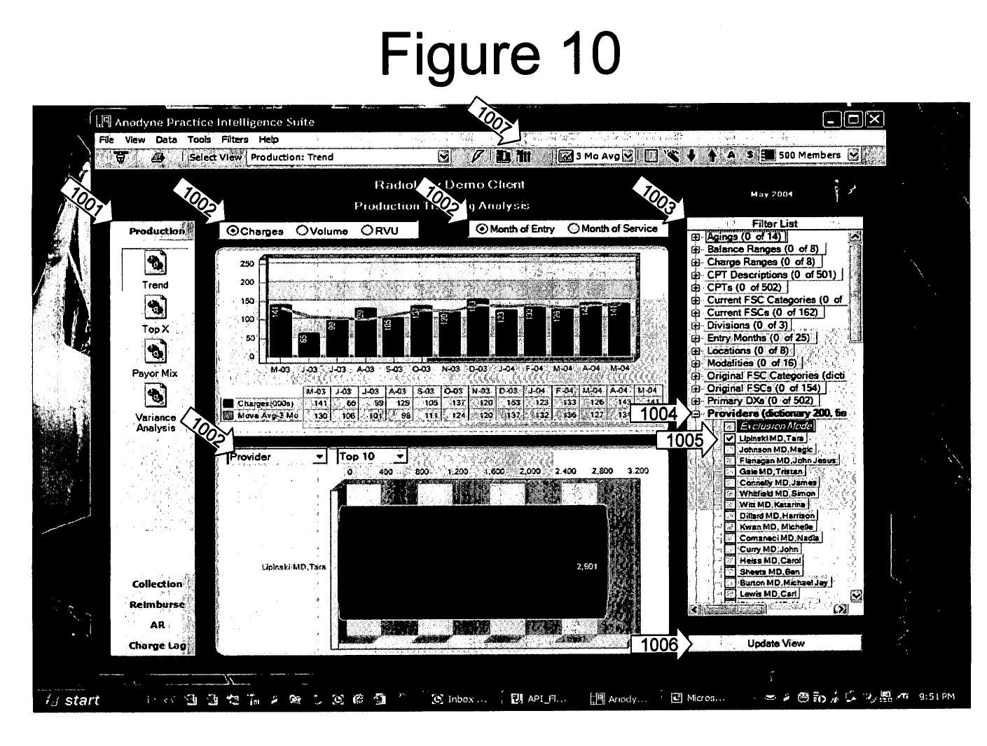

FIG. 10 is modified version of the user screen of FIG. 9 illustrating in more detail the controls available to a user to change and modify views in a preferred embodiment. Visualization selection control 1001 enables the user to navigate between views. Visualization perspective controls 1002 enable the user to change perspective on currently visible views based on different productivity metrics [e.g. charges, volume, relative value unit (RVU)], calendaring metrics (month of entry, month of service) and group metrics (provider, etc.).

Filter list 1003 is a tree-like list that may be employed to change, on “per member” basis, the data that feed into the currently visible charts. Dimension control 1004 represents the top level of filter selection. In this illustration, healthcare providers have been selected. Member control 1005 is a sub-dimension control that points to a particular member of within the selected dimension. In this illustration, the member “Lapinski MD, Tara” within the “Providers” dimension has been selected. Upon filling the check box for this member and clicking “Update View” button 1006, the charts are updated with data relating only to Tara Lapinski, MD. If the user had also filled the “Exclusion Mode” check box prior to clicking “Update View” button 1006, the charts would have been updated with data relating to all providers except Tara Lapinski, MD. It will be appreciated that the user gains tremendous flexibility by being able to select any combination of members from the various dimensions that make up filter list 1003. It bears noting that the names, content, and number of dimensions and members that appear in the filter list are adjustable based on the needs of the target audience.

Excel export detail button 1007, when depressed, initiates a process by which a user can extract and export into a Microsoft Excel spreadsheet detail data records, or a selected portion thereof, which are being summed to populate the current visualization.

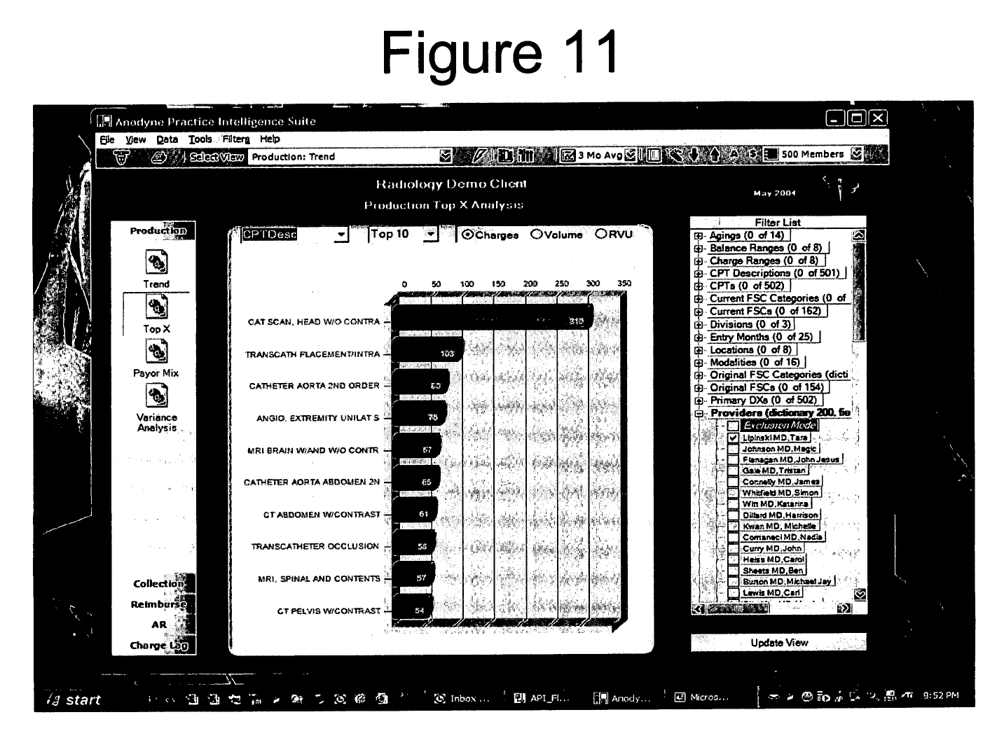

FIG. 11 is an exemplary user screen illustrating a production top “X” analysis presented to a user. This view provides the user access to the top “X” members within any available dimension. As in virtually all top “X” functionality within this application, the charge dollar value of the each member determines whether it qualifies. The dimension and top “X” selections are made within the combo boxes at the top of the visualization. A single production metric (charges, procedure volume or RVUs) is also to be chosen from the option box at the top of the chart. As in all views, the user can filter on any combination of members from the available data dimensions within the filter list.

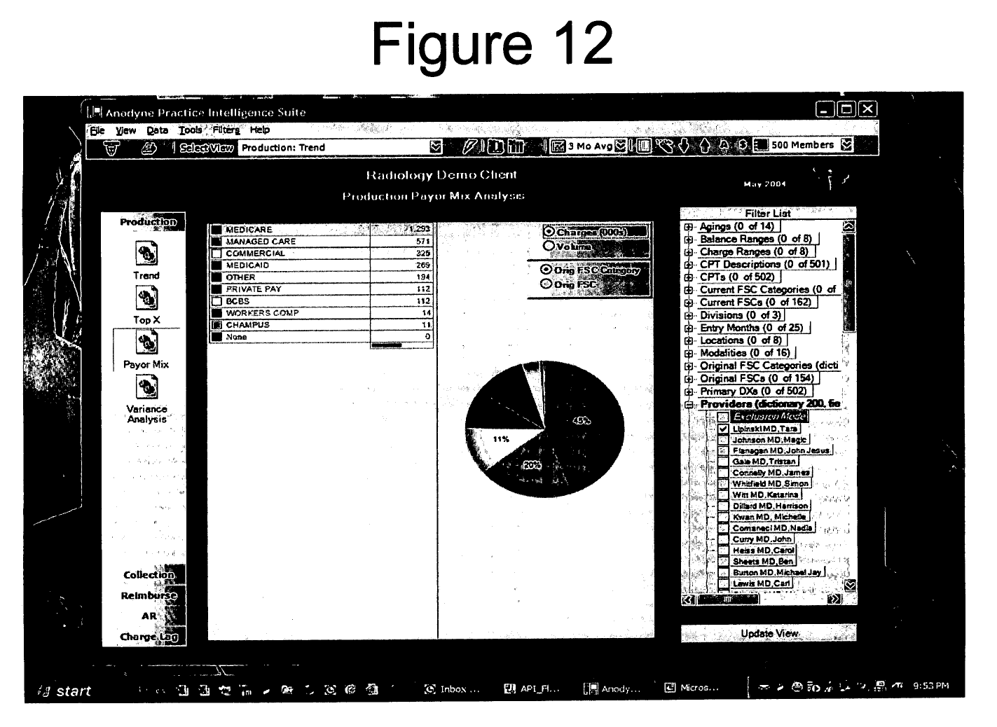

FIG. 12 is an exemplary user screen illustrating a production payor mix analysis presented to a user. This view provides the user with a payor mix pie chart, and corresponding data table based on either charges or procedure volume. The payor mix data can be visualized by either the original financial services class (FSC) reporting category dimension or the original FSC dimension. Percentages are displayed on the top three members within the pie chart and can be accessed on all dimensions through tool tip functionality. A descending order sort, by percentage of mix, is in place for this visualization starting at the top of the pie and moving counter-clockwise.

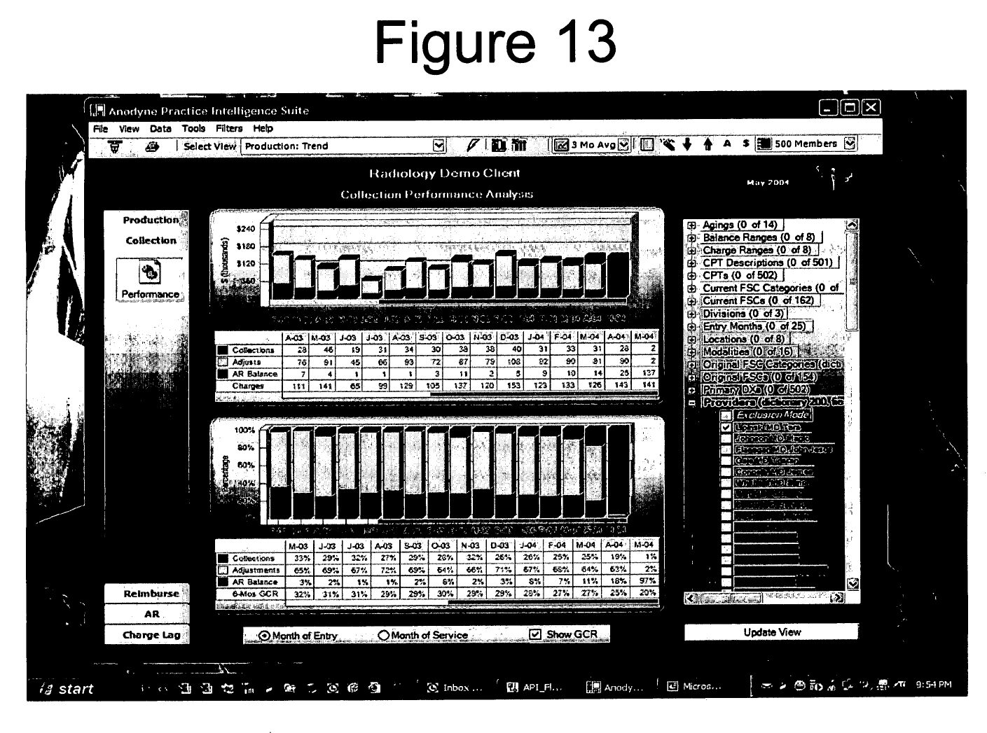

FIG. 13 is an exemplary user screen illustrating a collection performance analysis presented to a user. This view provides the user with two charts that match charge resolution categories, including collections, adjustments and AR, back to the month of entry (transaction month) or month of service. The top chart provides data points with dollar value quantification, while the bottom chart presents the same data points on a percentage scale. Both charts represent charge resolution categories in a stacked column format with corresponding data tables. In addition, each of these charts has a horizontal scroll bar enabling full access to 24 months worth of data. Active tool tip functionality will display the values associated with each component (metric/color) of each column.

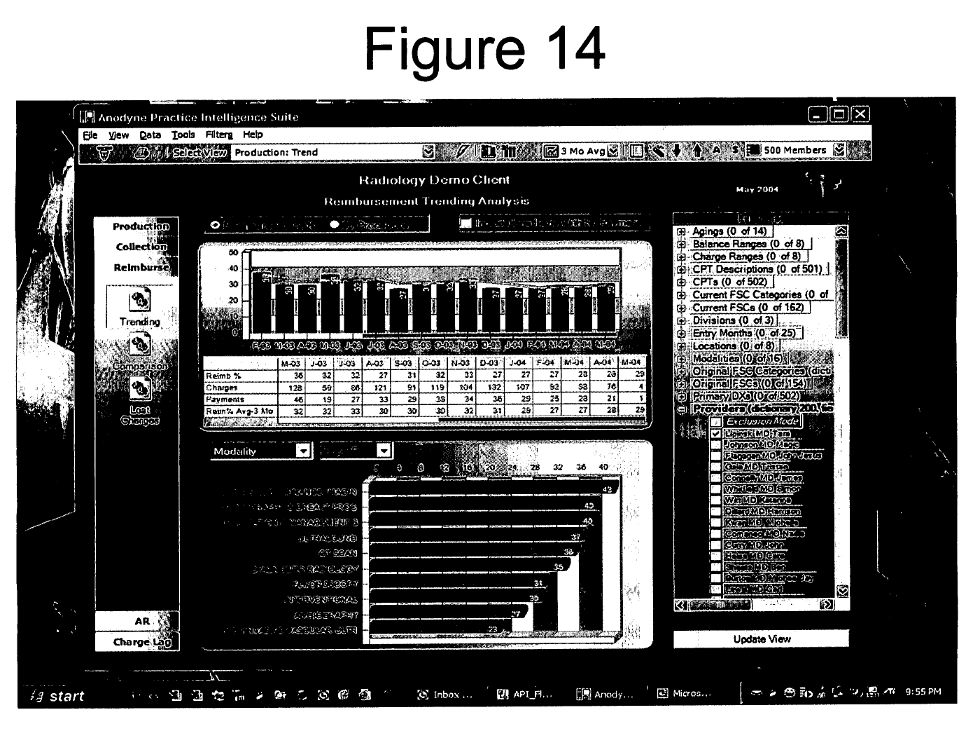

FIG. 14 is an exemplary user screen illustrating a reimbursement trending analysis presented to a user. This view contains two charts that enable the user to analyze reimbursement rates, or the cash yield metric (payments per procedure), across all available dimensions. In this view, as well as the two additional views within the reimbursement view category, all procedure data records with existing AR have been excluded so that the user con conduct a true study of reimbursement levels. This means that all months, including the most recent month, should provide an accurate picture of reimbursement rates, as only closed (no AR remaining) line-items are included. The top chart provides a 24-month trend of reimbursement across all filtered data records. There is a horizontal scroll bar to enable access to the full 24-month period. Additionally, there is a three-month moving average trend line that can be adjusted using the combo box in the top right section of the tool bar. The bottom chart enables the user to cut the data by any available dimension and display the top “X” members, based on charge levels. These members are sorted in descending order based on reimbursement rates.

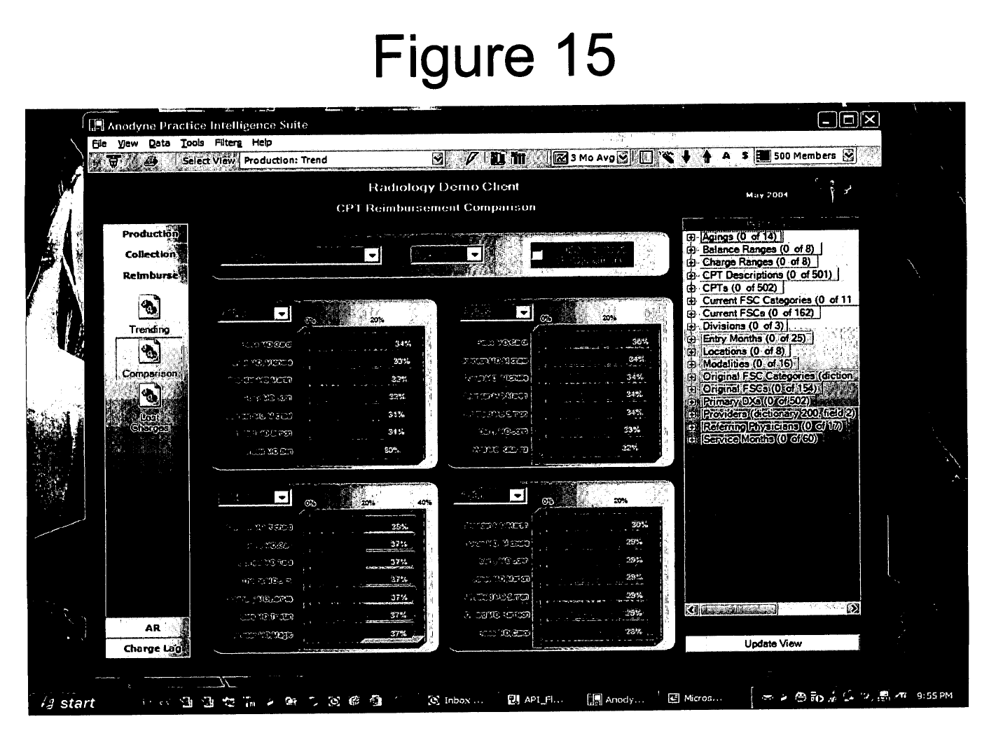

FIG. 15 is an exemplary user screen illustrating a CPT reimbursement comparison presented to a user. This view contains four identical charts that enable the user to simultaneously analyze the reimbursement rates of four different CPT codes (with or without an integrated modifier). A dimension combo box provides flexibility in how the data is cut within these visualizations. Moreover, a top “X” combo box enables the user to restrict the members that display to those with the largest impact on the practice (by charge dollar value). These members are displayed in descending order, by reimbursement rate, within the four bar charts. Finally, a vertical scroll bar gives the user full access to all data points within the charts. As with the previous reimbursement view, only line items that have no remaining AR qualify for this view.

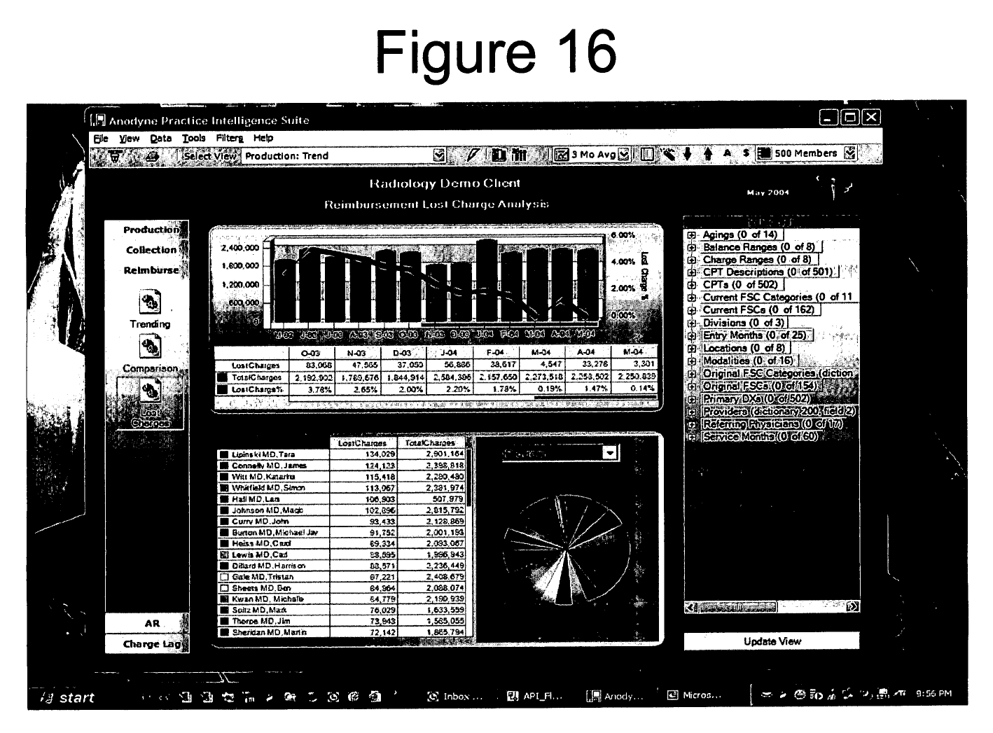

FIG. 16 is an exemplary user screen illustrating a reimbursement lost charge analysis presented to a user. This view contains two charts that enable the user to analyze charges that have been closed out with no reimbursement. The adjustment reason (i.e. bad debt, bundling, within global period, etc.) utilized as part of the write off transaction has absolutely no bearing on this view. The top chart shows a 24-month trend of lost charges, total charges and the corresponding percentage of these metrics (lost charge %). There is a horizontal scroll bar to give the user full access to all monthly data points. In the bottom chart there is a dimension combo box which enables the user to determine the dimension that will be used to divide the pie chart. All members of the dimension will be displayed in descending order, by lost charge dollars, starting at the top of the pie chart and moving counter clockwise. A vertical scroll bar within the data table of the bottom visualization enables the user to access all member data points.

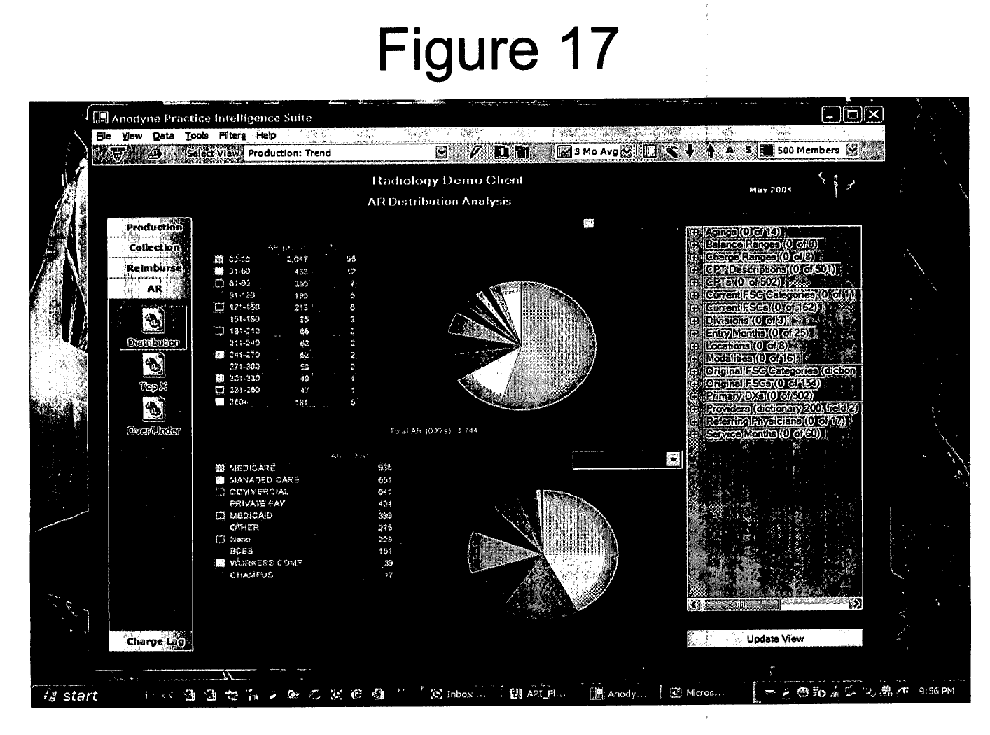

FIG. 17 is an exemplary user screen illustrating an accounts receivable distribution analysis presented to a user. This view contains two charts that enable the user to analyze accounts receivable by any available dimension, as well as by age. Each of the charts is driven by a pie chart and a data table. The top chart displays the members of the selected dimension (i.e. current FSCs) by AR total. The members within this chart are displayed in descending order starting at the top of the chart and moving counter clockwise. The bottom chart shows the aging “buckets” in logical order (i.e. current, 30, 60, etc.) from the top of the chart and moving counter clockwise as well. Each slice within each pie chart has tool tip functionality activated and will quantify the respective percent and dollar value of the aging members.

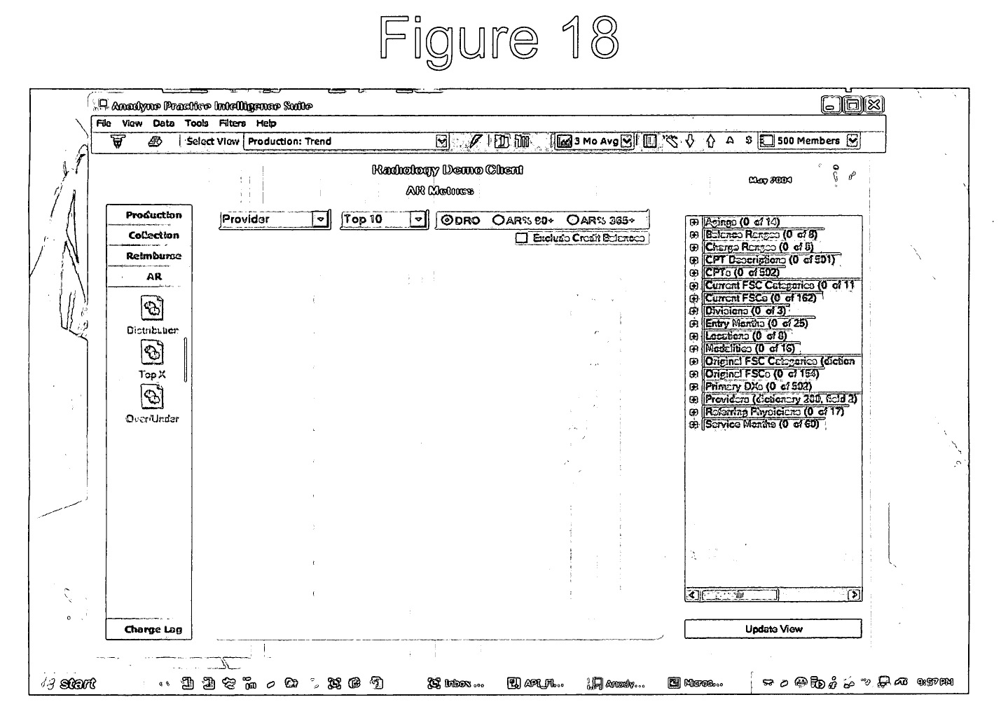

FIG. 18 is an exemplary user screen illustrating accounts receivable performance metrics presented to a user. This view contains a bar chart that displays the AR performance metrics identified in the referenced figure. A dimension combo box enables the user to view the top “X” members (by charge dollaor) of the selected dimension (i.e. current FSC). This functionality is available for each AR metric.

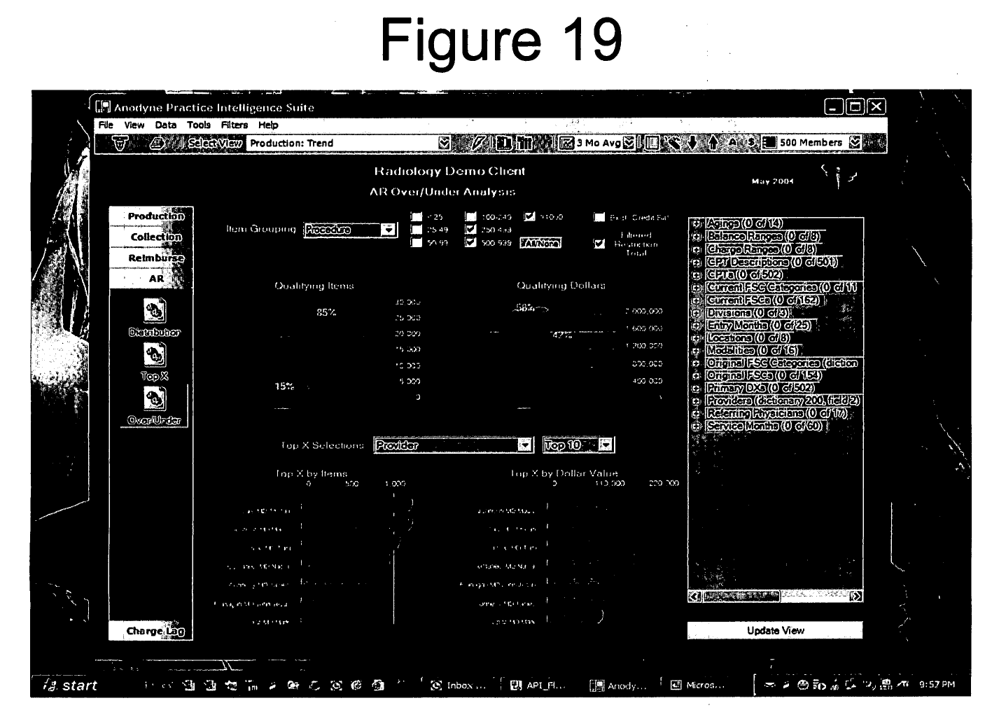

FIG. 19 is an exemplary user screen illustrating an accounts receivable over/under analysis presented to a user. This view has several charts that enable the user to target AR by dollar value, whether at a procedure, invoice or patient level and display that AR by any available dimension, both for volume and dollars. The initial user process is to select the item grouping methodology and then to apply the dollar value restrictions that are desired. The top two charts will then display the number of AR items that qualify (and that don't qualify), as well as the AR dollars that qualify (and that don't qualify). The bottom two charts will cut the data by the selected dimension and will do so for the number of members desired (top “X” combo box). The top “X” in this instance is driven by the actual value of the member, whether it be volume of AR items or AR dollar levels. If the user applies a filter, and the “filter restriction total” check box is checked, the top two charts will display the qualifying percent using the filtered total (volume or dollars) in the denominator. If the “filter restriction total” is unchecked, the denominator will be taken from the entire data set (i.e. practice's total open AR items and dollars).

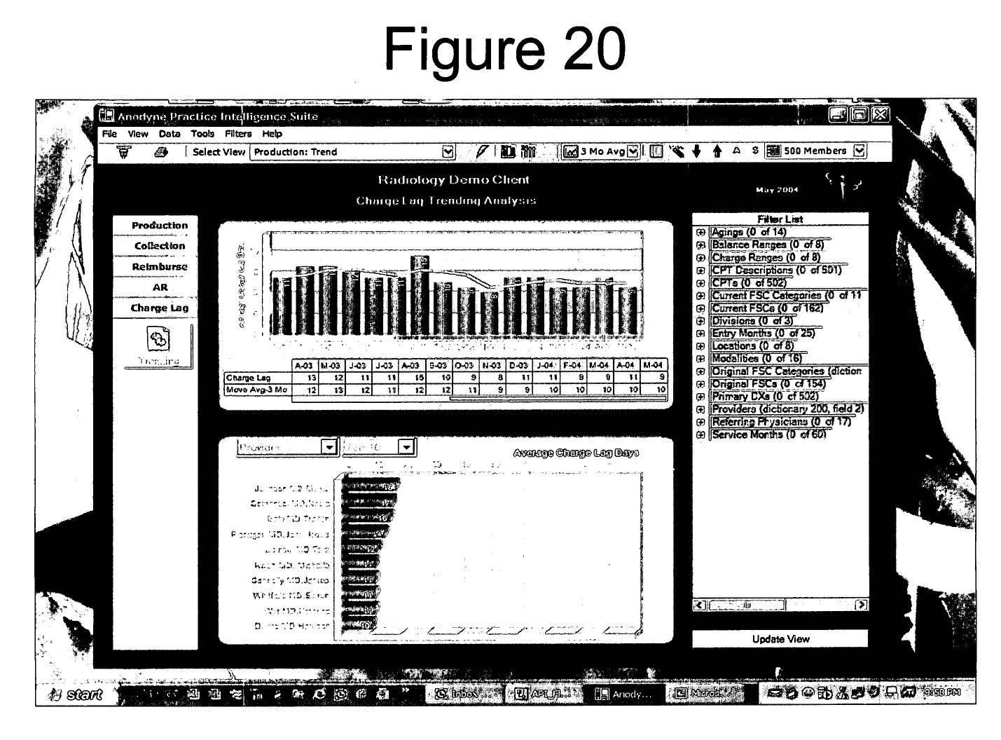

FIG. 20 is an exemplary user screen illustrating a charge lag trending analysis presented to a user. This view has two charts that enable the user to analyze charge lag performance over time and across any available dimensions. In the top chart, there is a 24-month trend of charge lag which can be fully accessed using the horizontal scroll bar provided. Included in this is a moving average trend line which can be adjusted using the moving average combo box in the top right section of the tool bar. In the bottom chart, the user can cut the data by any available dimension and limit the members that display with top X functionality. The top X filter uses charge dollar value as the driver of qualifying members.

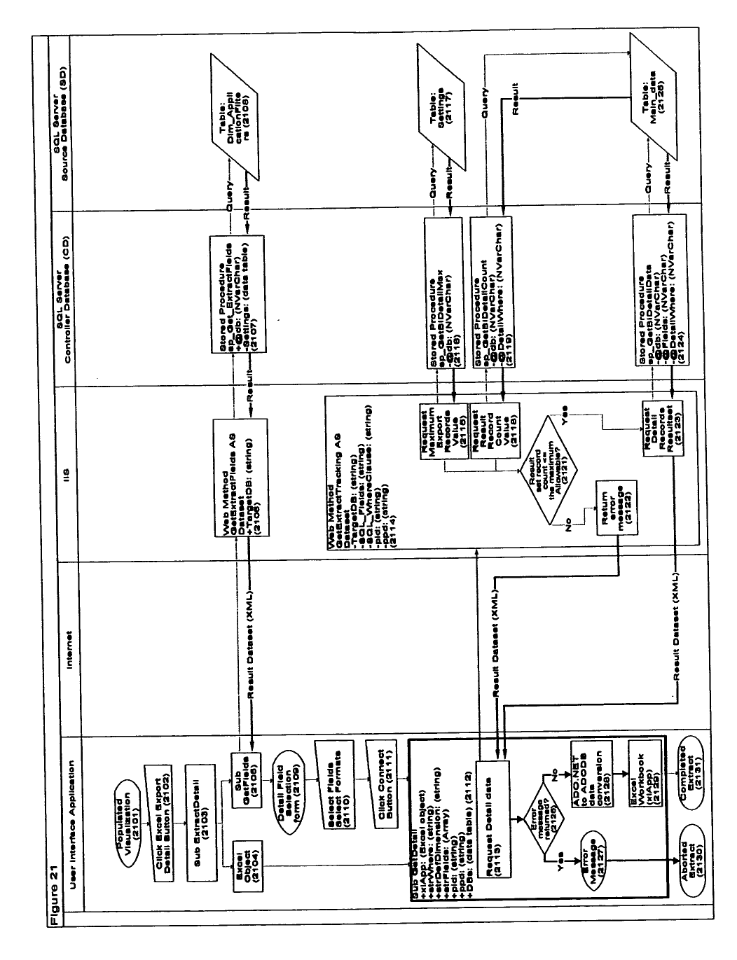

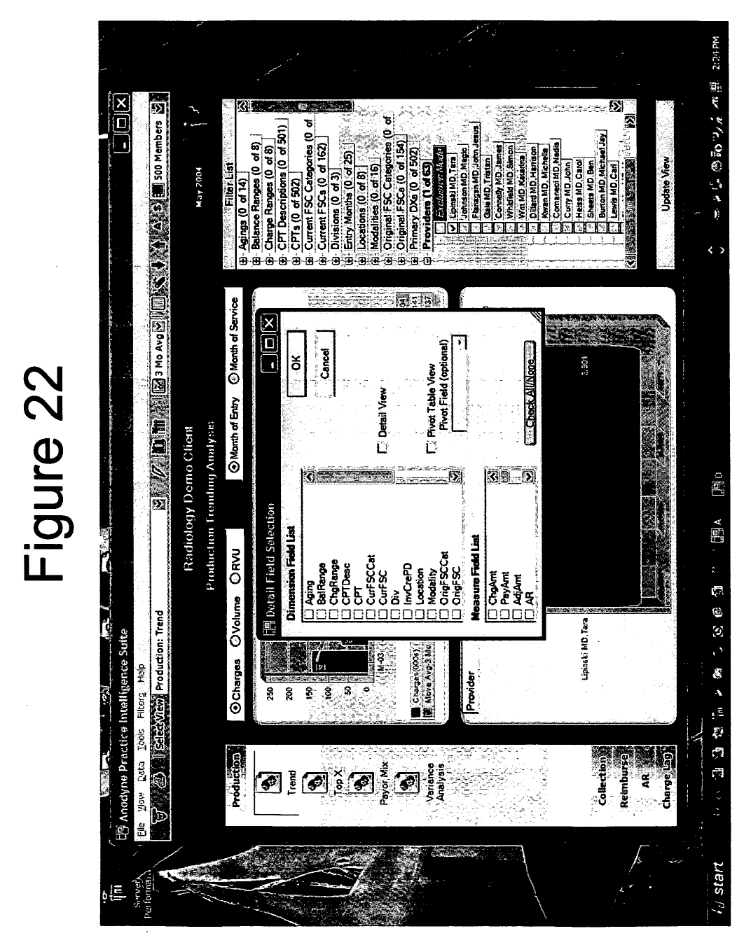

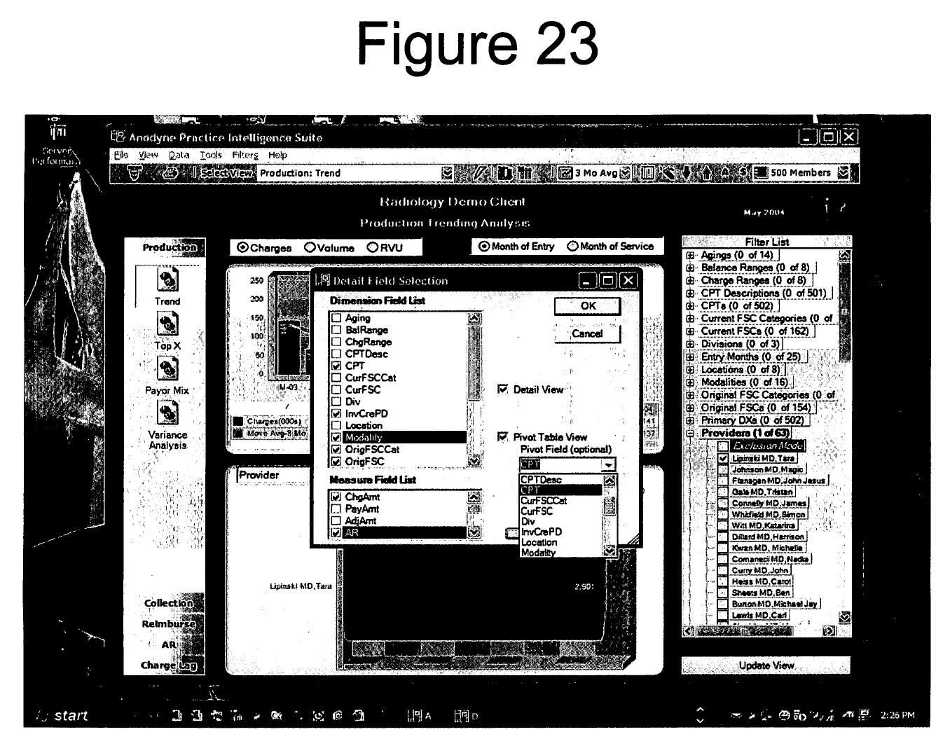

Turning to FIG. 21 in conjunction with FIGS. 22 and 23, a process for extracting and exporting detail data records in accordance with a preferred embodiment is illustrated. From a populated visualization, such as FIG. 10, the user clicks an Excel export detail button 1007 (2101, 2102). Depressing button 107 initiates a call to extract detail function 105 (2103). Additionally, an Excel object is created on UIA 10 (2104). The GetFields subroutine on UIA 10 calls the GetExtractFields web method on WSA 20 and passes parameters (2105). The GetExtractFields web method in turn issues one or more commands to the GetExtractFields stored procedure on controller database 30 (2106) which in turn queries the settings and DimApplicationFilters table on the selected one of source databases 40 (2108). The DimApplicationFilters table stores the extractable fields for populating the Dimension Field List and the Measure Field List shown, for example, on FIG. 22. The GetExtractFields stored procedure returns the extractable fields as an ADO.NET dataset to WSA 20 which relays the dataset to UIA 10. UIA 10 creates and displays a populated Detail Field Selection form shown, for example, on FIG. 22 (2109). The user selects fields and formats for extraction and export as shown, for example, in FIG. 23 (2110) and clicks the connect (OK) button (2111).

At this point, the GetDetail VB.NET sub-procedure on UIA 10, and more particularly a request detail data code section, calls the GetExtractTracking web method on WSA 20 and passes parameters (2112, 2113). The GetExtractTracking web method, and more particularly a request maximum export records code section (2114, 2115), issues one or more commands to the GetBIDetailMax stored procedure on controller database 30 (2116) which in turn queries the settings table on the selected one of source databases 40 (2117) to determine the maximum allowable number of detail records. Additionally, the GetExtractTracking web method, and more particularly a request result record count code section (2114, 2115), issues one or more commands to the GetBIDetailCount stored procedure on controller database 30 (2119) which in turn queries the main data table on the selected one of source databases 40 (2125) to determine the requested number of detail records. The maximum allowable number of detail records and the requested number of detail records are returned to WSA 20 and compared (2121).

If the requested number is greater than the maximum allowable number, WSA 20 returns an error message to UIA 10 (2122). If, however, the requested number is less than or equal to the maximum allowable number, the GetExtractTracking web method, and more particularly a request detail records code section (2114, 2123), issues one or more commands to the GetBIDetailData stored procedure on controller database 30 (2124) which in turn queries the main data table on the selected one of source databases 40 (2125) for the requested detail records. The GetBIDetailData stored procedure returns the detail records as an ADO.NET dataset to WSA 20 which relays the dataset to UIA 10.

At that point, UIA 10 determines if an error message was returned (2126). If an error message was returned, an error message is displayed on the user interface (2127) and extract detail function 105 is aborted (2130). If an error message was not returned, however, the ADO.NET dataset is converted to ADODB (2128) and passed to an Excel workbook (2129). An Excel workbook is a file that contains one or more spreadsheet pages. A visualization of the Excel workbook is displayed on the user interface, marking successful completion of extract detail function 105 (2131).

It will be appreciated by those of ordinary skill in the art that the invention can be embodied in other specific forms without departing from the spirit or essential character hereof. The present description is therefore considered in all respects illustrative and not restrictive. The scope of the invention is indicated by the appended claims, and all changes that come within the meaning and range of equivalents thereof are intended to be embraced therein.

We claim:

1. A method for presenting healthcare revenue cycle data on a first computer node having a user interface, comprising the steps of:
displaying on the user interface a first visualization for a first healthcare revenue cycle performance metric;
displaying on the user interface a visualization control that is operable by a user to select a second visualization for a second healthcare revenue cycle performance metric; and
displaying on the user interface a second visualization for a second healthcare revenue cycle performance metric.

2. The method of claim 1, wherein the first healthcare revenue cycle performance metric is a first one and the second healthcare revenue cycle performance metric is a second one of production trending, production top “X”, production payor mix, collection performance, reimbursement trending, CPT reimbursement, reimbursement lost charge, accounts receivable distribution, accounts receivable over/under and charge lag trending.

3. The method of claim 1, wherein the first and second visualizations are generated from data for a single healthcare organization.

4. The method of claim 1, wherein data used to generate the first and second visualizations are received from a second computer node communicating with the first computer node via the Internet in response to an action by the user within a healthcare revenue cycle user interface application.

5. The method of claim 4, wherein a healthcare revenue cycle user interface application on the first computer node interacts with a web services application on a second computer node to obtain data used to generate the first and second visualizations.

6. A method for presenting healthcare revenue cycle data on a first computer node having a user interface, comprising the steps of:
displaying on the user interface a first chart for a healthcare revenue cycle performance metric based on a first healthcare revenue cycle data population;
displaying on the user interface a filter control that is operable by a user to select a second healthcare revenue cycle data population; and
displaying on the user interface a second chart for the healthcare revenue cycle performance metric based on the second healthcare revenue cycle data population.

7. The method of claim 6, wherein the filter control is operable within a tree-like filter list.

8. The method of claim 7, wherein the tree-like filter list includes one or more dimensions and one or more members within each dimension, and wherein the filter control is operable to select one or more of the members.

9. The method of claim 8, wherein only data associated with a selected member are included in the second healthcare revenue cycle data population.

10. The method of claim 8, wherein only data not associated with a selected member are included in the second healthcare revenue cycle data population.

11. The method of claim 6, wherein the healthcare revenue cycle performance metric is one of production trending, production top “X”, production payor mix, collection performance, reimbursement trending, CPT reimbursement, reimbursement lost charge, accounts receivable distribution, accounts receivable over/under and charge lag trending.

12. The method of claim 6, wherein data comprising the first and second healthcare revenue cycle data populations are received from a second computer node communicating with the first computer node via the Internet in response to an action by the user within a healthcare revenue cycle user interface application.

13. The method of claim 6, wherein a healthcare revenue cycle user interface application on the first computer node interacts with a web services application on a second computer node to obtain data comprising the first and second healthcare revenue cycle data populations.

14. A method for accessing healthcare revenue cycle data on a first computer node having a user interface and communicating with a second computer node via the Internet, comprising the steps of:
transmitting to the second computer node user information;
receiving from the second computer node in response to the user information an identification of one or more authorized healthcare revenue cycle data resources;
transmitting to the second computer node a request for healthcare revenue cycle data from one or more of the authorized healthcare revenue cycle data resources;
receiving from the second computer node in response to the request the healthcare revenue cycle data; and
displaying on the user interface a visualization based on the healthcare revenue cycle data.

15. The method of claim 14, wherein a healthcare revenue cycle user interface application on the first computer node interacts with a web services application to obtain the healthcare revenue cycle data from the second node.

16. The method of claim 14, further comprising the step of:
displaying on the user interface a filter control that is operable by a user to modify the visualization.

17. The method of claim 16, wherein the filter control is operable within a tree-like filter list.

18. The method of claim 17, wherein the tree-like filter list includes one or more dimensions and one or more members within each dimension, and wherein the filter control is operable to select one or more of the members.

19. The method of claim 14, further comprising the step of:
displaying on the user interface a visualization control that is operable by a user to modify the visualization.

20. A method for presenting healthcare revenue cycle data on a first computer node having a user interface, comprising the steps of:
displaying on the user interface a first chart illustrating collection performance data for a plurality of time periods on a dollar scale; and
while displaying the first chart; and
displaying on the user interface a second chart illustrating collection performance data for the plurality of time periods on a percentage scale.

21. The method of claim 20, further comprising, while displaying the first and second charts, the step of:
displaying on the user interface a first data table illustrating collection performance data for a plurality of time periods on a dollar scale; and
displaying on the user interface a second data table illustrating collection performance data for the plurality of time periods on a percentage scale.

22. The method of claim 20, wherein the collection performance data include data for a plurality of charge resolution categories for each of the plurality of time periods.

23. The method of claim 22, wherein the charge resolution categories include collections, adjustments and accounts receivables balance.

24. The method of claim 22, wherein the data for the plurality of charge resolution categories are presented as stacked columns within the first and second charts.

25. The method of claim 20, wherein the percentage scale is a 100% scale.

26. A method for presenting healthcare revenue cycle data on a first computer node having a user interface, comprising the steps of:
displaying on the user interface a first visualization for a first application based on healthcare revenue cycle data;
displaying on the user interface a control for the first application that is operable by a user to select at least part of the healthcare revenue cycle data for export to a second application; and
displaying on the user interface a second visualization for the second application based on at least part of the healthcare revenue cycle data.

27. The method of claim 26, wherein the first application is a healthcare revenue cycle user interface application.

28. The method of claim 26, wherein the second application is a spreadsheet application.

29. The method of claim 26, wherein data used to generate the first and second visualizations are received from a second computer node communicating with the first computer node via the Internet in response to an action by the user within the first application.

30. The method of claim 26, wherein a healthcare revenue cycle user interface application on the first computer node interacts with a web services application on a second computer node to obtain data used to generate the first and second visualizations.
